(19) United States
(12) Patent Application Publication
(10) Pub. No.: US 2011/0097508 A1
(43) Pub. Date: Apr. 28, 2011

(54) Method and apparatus for mixing and feeding solid matter and binder

(75) Inventors: Rauno Lautanen, Hyvinkaa (FI); Markku Karhumäki, Hyvinkaa (FI)

(73) Assignee: FINNCABIN LTD, Hyvinkää (FI)

(21) Appl. No.: 12/997,614

(22) PCT Filed: Jun. 15, 2009
(86) PCT No.: PCT/FI2009/050517

§ 371 Date: Dec. 13, 2010

(30) Foreign Application Priority Data
Jun. 13, 2008 (FI) 20085581

(51) Int. Cl. B05D 1/02; B01F 5/20; C08F 2/48; C08J 7/18

(52) U.S. Cl. 427/508; 366/137.1; 427/553; 427/421.1; 427/427; 427/427.4

(57) ABSTRACT

An apparatus and a method for coating of surfaces with a combination of a solid material and a binder, so that despite of the unevenness of the area to be coated, a desired evenness is obtained controllably. In the invention the filler is slung through the liquid binder and that binder not captured by the filler particles onto their surfaces is recovered and reused.

The present invention relates to a method according to the preamble of claim 1 for mixing of a solid material and a binder, as well as for forming a surface layer consisting of this kind of a mixture onto a substrate.

In the method, a solid material is contacted with a liquid binder to form a mixture, and the mixture containing the solid material and the binder is sprayed onto a substrate.

The method can be used for eg. paving roads and comparable uneven areas as well as for making markings on even surface layers.

The invention also relates to an apparatus according to the preamble of claim 12. This kind of an apparatus has feeding devices for the solid material, feeding devices for the binder, as well as a mixing zone for the solid material and the binder, wherein the solid material and the binder can be mixed together,

Especially in construction and related functions, filler and an adhesive are mixed together, the mixture is laid down or sprayed to a desired location, and it is let to harden or stiffen. Road asphalting is a common example, wherein hot bitumen is blended with rock material, the mixture is laid down onto the road surface and steamrolled flat. A mixture of cement, water and sand that can be blast with the aid of air pressure to the wall, and thus obtaining plastering or concreting, should be mentioned as another example. Air is the propellant in producing concrete sprayings, and in some cases carbon dioxide, providing kinetic energy for the material, so that the particles will set dense onto the coatable surface.

An apparatus suitable for jet spraying of concrete mass is described in Finnish patent application 882561, wherein a concrete mass is mixed in a conventional manner in a power mixer, the mixture is transferred by means of a suction screw conveyor into a chamber, and it is aspirated therefrom into air stream, that gives a sufficient speed for it in order the mass to be thrown eg. onto a wall.

US patent publication 4,323,314 describes how filler is laid down into an enclosed container, so that its cross-section forms a circle, a liquid binder being sprayed from both sides thereof. The mixture is let to flow in the vessel, and to a desired placing location from the vessel.

As for US patent publication 4,832,497, a solution is described for producing a road pavement material, in which method gravel is divided into two fractions according to their sizes, and a bitumen emulsion is spayed separately into both fractions. Fractions are combined after this, and they are laid down gravitationally to the setting place. The purpose of the solution is to optimize the amount of binder, since the fines need more binder than coarser material due to its surface area.

In US patent publication 2,064,807, gravel is divided through an inverted V-shaped distributor to flow by two sides of the distributor and thus the binder can be sprayed onto both sides of the gravel stream. A similar solution is depicted in US patent publication 4,323,314, wherein the application is however slightly different.

In these foregoing patents, a material that already contains binder is flowinh in a container and/or on a distributor along a stationary wall.

DE patent 42 02 459 relates to a method for road paving, in which method hot bitumen is sprayed from several jet nozzles, so that spraying covers the whole desired lane and that there are two or more spraying nozzle groups in order to adjust and modify spraying more easier as necessary.

In SE patent publication 87347 is shown how gravel is scattered, by means of a conveyor and gravity as well as with pressurized air jet, onto the road surface, and binder is sprayed from above onto it along the range of the setting nozzle and the road surface.

FR patent publication 2 626 593, for its part, explains how binder is sprayed through gravel that runs gravitationally to the road and at the same time the same binder is sprayed onto the road surface before that point where the pretreated gravel is falling.

In all abovementioned solutions such a drawback exist, apart from two last mentioned, that the already “coated” material flows along different walls and thus causing needs for cleansing and needs for removing the hardened or stiffened material. On the other hand, SE patent 87347 and FR patent 2,626,593, wherein a binder is sprayed gravitationally among the flowing stone material, have an disadvantage, that a part of the binder does not contact the surface of the stone material.

Furthermore, in the known solutions, there exists a problem that settling of the mass onto the surface of a road or another surface is “loose” and always requires rolling afterwards.

The aim of the present invention is to eliminate at least some of the drawbacks relating to the related art and to provide totally new solution for mixing and feeding a filler and a binder.

The present invention is based on the idea that a stream of a solid material, that has speeded up by mechanical energy, “is shot” through a liquid binder or another liquid, this liquid being in a form of a film or a jet or the like, essentially planar to the direction of the flow. While the solid material penetrates the liquid film or the liquid jet, it captures a binder or another liquid along, which adheres to the surface of the solid material, after which the solid material stream can be directed onto a substrate in order to coat it.

According to the invention, that part of the liquid shower or the liquid film that has not been attached onto the surface of the solid material, is recovered from the opposite side of the solid material stream and is reused.

Solid material is slung through a binder or liquid shower towards to the surface to be coated, most suitably at a speed, that will not cause splashing or rebounding, the liquid/binder that has not been attached to the solid material is recovered and reused.

The solution can be carried out in an apparatus which has accelerating means for the solid material, which has been equipped with inlet for the solid material and with an outlet for the accelerated solid material, whereby the solid material that is brought via the inlet can be accelerated in the accelerating device to the desired speed by means of mechanical energy and it can be removed as a continuous stream via the outlet. The apparatus has also feeding nozzles for the binder arranged near the outlet, nozzle being been connected to the source of the binder and with help thereof a stream can be formed from the binder, streaming direction of the stream being at least essentially transversal in relation to the stream of the accelerated solid material. The binder stream is arranged between the outlet of the accelerating means and the substrate so that solid material stream to be removed as a continuous stream from the accelerating means is forced to go through the binder stream.

For recovering and recycling the binder, the apparatus has most suitably collecting means for binder stream on the other side of the solid material stream that has for example arranged contrarily in relation to the feeding nozzle. nozzles or the similar means for recovering the binder stream.

More specifically said, the method according to the present invention is mainly characterized by what is stated in the characterizing part of claim 1.

For its part, the apparatus according to the invention is characterized by what is stated in the characterizing part of claim 12.

Considerable advantages are obtained with the present invention. Thus, almost every particle led through the liquid stream gets a liquid coating, and no excess liquid binder or another material are needed. According to the invention, the velocity of the solid material particles can be adjusted, thickness of the liquid film or spray can be adjusted and defining the area to be sprayed can be adjusted.

Especially the stream of the solid material can be delimited with fixed or adjustable delimiters, by which an exact boundary can be obtained between the surface to be coated and the uncoated surface.

Furthermore, a great advantage of the above described method is that the binder is consumed according the area, that any amount of the solid material in question represents, and dosing of the binder does not need to be adjusted separately, but it is adjusted by itself. The excess of the binder is recovered from the opposite side and returned to the original feed.

The solution according to the invention can be applied at least for the following purposes:
for paving of roads and in particular track patching
for making road markings, safety passages, road side markings etc.
for furnishing special coatings or for tennis courts, race courses etc.
for producing or maintaining skiing tracks.

When areas are coated with the present filler/binder combination, then irrespective the possible unevenness of coated the area, the desired evenness is obtained controllably.

In the following, the invention will be examined more closely with help of the detailed description while referring to the appended drawings, wherein

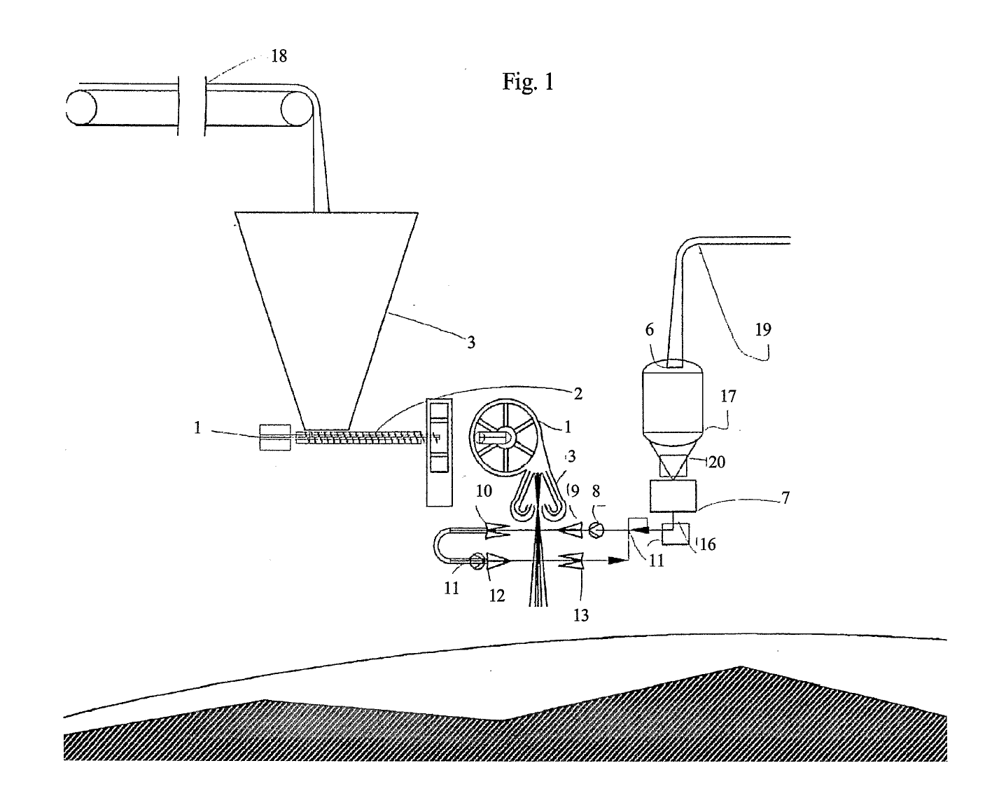

in FIG. 1 is shown as a side-view a skeleton diagram of the basic setting of the apparatus according to the invention, wherein the solid material stream obtained from an acceleration device, eg. from a sling, is led onto a substrate to be coated through the binder jet

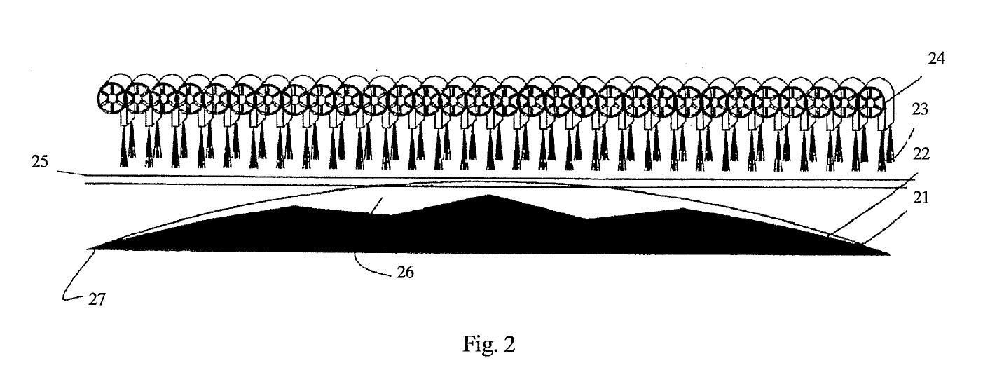

in FIG. 2 is illustrated as a side view a device solution having multiple parallel slings,

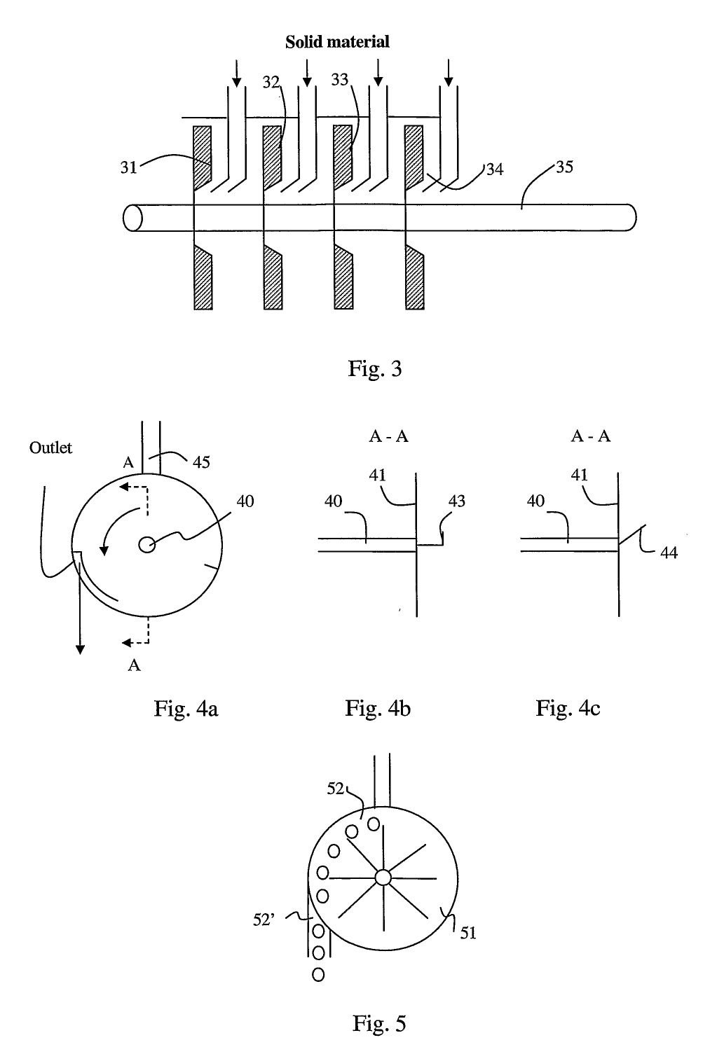

in FIG. 3 is illustrated as a side view such a solution which has several slings arranged on the same axel,

in FIGS. 4a to 4c is illustrated a cross sectional top view (4a) of a principal structure of a sling used in one embodiment of the invention, wherein the wings are either slightly tilted (FIG. 4b) or they form a pocket for the solid material (FIG. 4c), and

in FIG. 5 is illustrated compartment sling solution as a cross sectional top view.

As it will become evident from above, solid material is slung in the invention through a binder spray or film before the solid material hits the surface to be coated. In a solution of the invention, the mixing zone of the solid material and the binder is thus provided by arranging two crossing streams. Streams of the solid material and the binder move most suitably in air and are preferably at least essentially perpendicular towards each other. In practice the filler is lead as a continuous stream through the liquid binder or another liquid, whereupon that part of this liquid the filler particles have not captured on their surfaces, are recovered and reused.

In the invention, by a “substrate” is meant generally an area or a surface to be coated. The area of this substrate can vary broadly, as does also the width of the substrate to be coated.

Especially preferably the invention is used for coating narrowish areas, such as grooves of road pavements and scuffs of that kind, as well as for marking boundaries in sports fields and producing and maintaining skiing tracks. Widhts of these areas are usually about from 0.1 to 250 cm, especially about from 1 to 150 cm, typically about from 1.5 to 75 cm.

The solid material used in the invention—eg. the “filler” or the “a pigment” has a grain size typically about from 0.01 to 25 mm (average diameter) and comprises eg. stone, scrap glass, plastic chips, bitumen or asphalt chips, coal, gum or crushed ceramics or crushed concrete or mixtures thereof, fragments of metal or metal ore or ice. The grain size of asphalt mass is usually about from 1 to 20 mm and smaller particles suitable for road marking mixes having size of about from 0.01 to 2 mm.

The grains can have the color of the desired coating or they can be essentially transparent or opaque. Particularly when the method is use for marking areas, it is preferred to use granules having the color of the marking, eg. white. However, the color of the marking can also be obtained by using colored binder or liquid phase of the binder.

According to our invention, the solid material stream passed through the binder spray is directed to the ground to be coated or marked or onto another substrate. Solid material stream can be obtained by accelerating mechanically the solid material particles eg. by slinging the solid material by means of centrifugal force. Most suitably the stream velocity is such that the mixture does not spatter back from the substrate. However, the velocity has to be sufficient to obtain good adhesion to the substrate. Usually operation is carried out at a speed range of 1 to 20 m/s. It is clear that the material, which has been slung onto its substrate at too high a velocity, can bounce back.

Bitumen, molten sulphur, different molten resins and polymers as molten or as hardening oligomers can be used as binders. The binder can also be water and the solid material can be ice, such as described below in more detail.

Viscosity, surface tension and nature of viscosity of the binder or the liquid have an effect on the behavior of the binder. Receiving of the excess liquid can be accomplished by a cone, from which the liquid is aspired by a pump back to the circulation, or preferably it can be taken onto a surface of a rotating roller, disc or metal belt, wherefrom it is scraped off and reused.

Usually, the aim is to spray a liquid or a liquid binder as a film or a curtain or another stream having a “flattened” cross-section through the slinging track of the solid material.

The advantage of a flattened stream is that the liquid/binder excess is easy to recover from the opposite side of the solid material stream. The width of the liquid or binder stream is at least equal to the width of the solid material stream. Most suitably binder stream is at least 1%, preferably at least 5%, especially about from 5 to 50% more wide than the solid material stream, in order to ascertain that the binder can be applied onto the surface of all solid material particles. The required width varies according to how far the liquid/binder stream is from the outlet because the solid material stream broadens to some extend on the way from the sling to the substrate.

In so far as the surface tension of the liquid is so high that it begins to form drops, binder is sprayed eg. at elevation in more layers from a separate slit nozzle. It is also possible to use more cone angle nozzles as feeding nozzle, from which the binder can be fed in form on liquid cone, whereby the nozzles are arranged so that their liquid cones cover each others so that the liquid amount of the covering location does not deviate more than about 10% from the liquid amount of other locations.

The binder and solid material streams are mainly directed perpendicular towards each other, typically the angle difference of streaming directions is about 90°±60°, preferably 90°±30°.

The surface to be coated is usually in horizontal position or in almost horizontal position, wherein the spraying of the solid material occurs vertically and binder film is arranged essentially parallel with the substrate. The advantage of this application is that the solid material flux advances linearly, whereupon its aligning is easy.

However, it is also possible to coat vertical surfaces as well as generally surfaces being at angle position in relation to the horizontal level. The angle in relation to the horizontal level can be about from 1 to 90 degrees.

The nozzles are preferably a flexible metal, distance of the jaws thereof can be adjusted also that purpose in mind, that the liquid collected from the opposite side is reused. If blockages begin to form in a nozzle, then by opening the gap of the jaws, the blockade can be cleaned.

Especially preferably the spraying of the liquid is carried out as a film. According to another alternative, the binder is sprayed from such a slit nozzle that the spray does not disperse, but it can be recovered from the other side.

Spraying can also be carried out by one or more cone spray nozzles and those spray cones are covering part of the adjacent cone.

Liquid used varies always according to the application. When applying the apparatus for producing asphalt or patch up worn out driving paths, bitumen is naturally used at least according to the present manner as the liquid, and a binder and a stone material as the solid material. As the solid material also old ground-away asphalt can be used. Also a water emulsion of bitumen can be used in place of molten bitumen.

When making road markings, the liquid can be molten sulphur, molten polymer or polymer emulsion or a polymer that is not yet crosslinked, and the filler can be white stone and white pigment. Colored pigment can naturally be mixed already to the polymer or the liquid.

According to a preferred embodiment, at least part of the solid materials, eg. the stone material, have been pretreated with the binder before it is fed through the shower curtain. In that case it gets more binder while moving through the shower curtain. Solid materials can be pretreated with a suitable binder for example with a storage silo.

In the presented embodiment when there is less binder than what is suitable amount for binding, the one can operate as follows: a) the solid material (eg. stones) is transferred with a simple screw to the slinging section and b) the pretreated stones are slung, in which case they take binder much more better from that shower or film, through which they are slung.

Most suitably about from 1 to 50 weight % of the final amount of binder, most suitably about from 10 to 35 weight % of the final amount of binder are mixed in advance to the solid material. This is about from 2 to 3% of weight of the solid material (stone material).

As a binder, either the same or different binder is used for the pretreatment and the actual moistening. Typically, eg. pitch or asphalt are used, but it is also possible to use two-component bitumen or two-component resin, in which case one component is brought at the first step and another at the second step.

Means for recovering of the liquid can be several, but at least a tilted cone, rotating disc or drum or metal band, wherefrom the liquid/binder is scraped away and reused. If the binder is hot, such as molten sulphur or bitumen, the recovery apparatus has to be a warmed one.

In the invention, a continuous flow is formed from a grain-like solid material and is directed onto the substrate. For forming a stream, an accelerating means is used, by which the solid material grains can be accelerated mechanically or pneumatically to an appropriate speed. Most suitably a mechanical sling is used. Accelerating of this kind of a solid material to a desired speed takes place suitably by means of centrifugal force. There can be several nozzle solution for the sling.

The sling of the apparatus can be narrow or even as wide as the length of the whole road, and, in terms of the width, it preferably can consist of modules, whereto material to be slung can be fed according to specified width stages, operating in such a way that material is fed only to one or several width stages and that the width stages are separated from each other by a dividing wall. A broad area can also be coated with a narrow sling, so that the sling travels a Z-path across the area and feeds more material into a deeper position than the adjacent one.

This operation can be controlled by two surface-height radars, one of which measures the reference height and the other the height of the position to be filled. Thus, according to one application, for filling and leveling an uneven surface, the uneveness of the surface is measured with the radar that moves before the filler, in which case the filler and the binder are dosed according to the unevenness, and the surface reference level is determined with the other radar from the other positions for the filling amount for the position to be filled.

In detail, the device according to FIG. 1 can be described as follows:

The sling is shown at position 1, as a rotating object, wherefrom a channel leads to an autogenous pocket 5, a screw 2 brings the solid material to the sling 1, from a silo 3. A pump 8 pumps the liquid through a nozzle 9 and the receiver 10 receives the excess liquid. A pump 11 pumps the excess liquid back through a nozzle 12, either to another receiver 13 and again the solid materials through a shower, or the pump 11 pumps the excess liquid back to position 14, where the unused liquid and used liquid encounter. Positions 16, 7 and 20 describe possible mixing places of the additive, which additives are mixed to the binder or the liquid coming from the container 17. Positions 6 and 19 describe a vent pipe of the liquid container.

Due to wearing, so called autogenous pocket is preferred, such as in FIG. 1 is illustrated at position 5. An autogenous pocket is not necessary according to the invention, but it can be replaced with a horn or an alley formed of two walls, the length of which varies always according to how broad coating is being carried out.

In FIG. 1, only an embodiment of such a device is illustrated, wherein the material sling is narrow, but it can also be broad, consisting of several, on the same axel, separated from each others with a dividing wall.

In FIG. 2, especially an apparatus that is suitable for spreading hot asphalt and track patching of concrete roads is illustrated. In FIG. 2, the use of many different narrow slings are explained.

First, the profile 21 of the old road is measured from the road. After this the desired surface 22 is determined Stone material (crushed stone) is sprayed onto the surface from the slings 24 that directs roughly speaking perpendicular to the road surface. Before the crushed stone spray hits the surface of the road, it goes through a binder film 25. With reference numbers 26 and 27 the positions of maximum/minimum stone material sprays are illustrated (to the position 26 considerably more stone material is fed than to the position 21).

With the process, for example the unevenness of the road surface can be repaired.

The same idea of operation, or different feed on different places, can be provided also with a one-axel sling, wherein the feed of the material to the sling has been realized in a modified way so that to the different section can be fed with different amounts of material, by altering rapidly the feed. The unevenness of the surface is examined eg. with a radar that guides the feed according to the place and depth.

FIG. 3 shows a multi-sling structure, wherein all slings 31 to 34 are on the same axel 35.

With the apparatus solid material, being stone, grounded rubber, brick rubble, concrete grit, coal grit, ice etc., can be fed.

As an example, a case can be mentioned, wherein hot sand is slung at the width of the road onto an icy road surface, whereupon sand is melt and adhered onto the surface and does not dust off with the air stream of passing-by cars. Another example is such that deep frozen ice crush is slung through the water at 0 degrees, in which case skiing beddings are formed rapidly onto terrain.

As noted above, organic materials, such as bitumen, different molten resins and polymers in melt state or as oligomers, as a binder can be used that will harden at the setting point by influence of eg. UV light or by influence of the fed catalyst. Molten sulphur can also be used. By using rubber and resin, tennis courts or other playfields and running tracts can be coated.

When using ice, eg. skiing tracts can be quickly repaired and created, such that ice crush is very cold, whereupon it cools quickly water that is used as a curtain spray.

The speed of the rotor of the solid material sling can be adjusted according to the quality of the substrate to be coated and quality of the solid material as well as viscosity of the binder and splattering alternating according to the surface tension. By this is meant that the solid material is slung at such a speed, that it does not bounce back, and the liquid of the binder does not splatter essentially for its part. Controlling and regulating of this function can be carried out by means of a light cells that are positioned alongside the strip to be coated horizontally near the surface to be coated. Usually circumferential speed of the rotor is about from 01 to 50 m/s, especially about from 1 to 20 m/s.

The sling used can preferably be a rotating disc having radial linear or backwards curving wings and output orifice, wherefrom solid material slings out in the direction of tangent. Solid materials flow in the centre of the sling, wherefrom it is accelerated to the desired speed by adjusting the speed of rotation. The adjustment of the feed is done by opening and closing eg. a constrictor valve of the feeding tube, or by adjusting the speed of rotation of the feeding screw.

Each width module can be separately adjusted in relation to the feed. In terms of wearing, it is preferred that the wings for the sling are slightly tilted against that disc 41, 42, whereto the wings 43, 44 are attached, or the free edge of the wings is turned so that it forms a pocket for the solid material. FIGS. 4a to 4c show these solutions (in FIGS. 4b and 4c, a cross section A-A is shown). Reference number 40 means the axel of the sling and 45 means the feeding pipe.

According to FIG. 5, the solid material can be slung also with a compartment sling 51, in which the solid material is fed to the perimeter 52 and it exits from the perimeter 52′.

The slinging apparatus can also be such that it is formed by two belts having hairs, spikes, bristles or otherwise flexible protuberances. These protuberance conveyors are contrarily in the belts and the stone material is dropped between then, in which case the stone material gets higher speed than in a conventional apparatus.

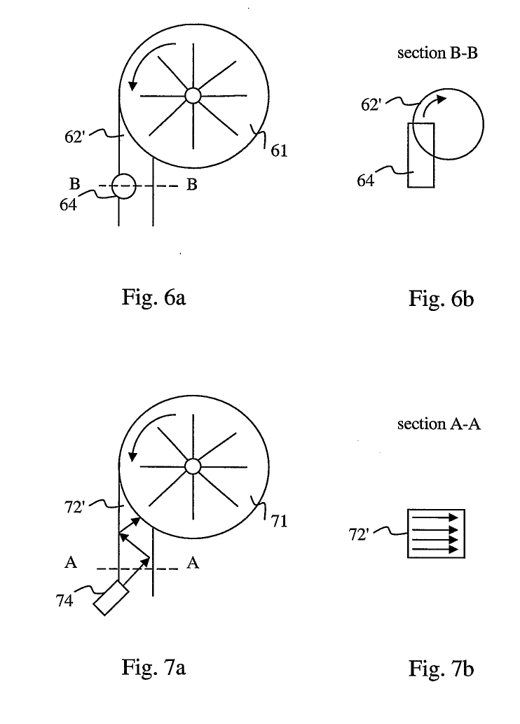

Referring to FIGS. 6a and 6b, according to one embodiment, the outlet pipe 62′ of the stone material comprises at least one curvilinear area, the outlet pipe being more preferably essentially circular according to the FIG. 6b. In that case the stone material arriving from the stone material sling 61 is contacted with bitumen or another binder so that this is fed essentially tangentially to the outlet pipe 62′ from an applicable spray 64 or the like. Feeding can be done essentially horizontally and finished product is directed from above to the surface to be coated. The advantage of this embodiment is that the binder stays hot and the adherence time with the stone material can be enhanced as the binder will reach a rotating motion in the tube. Furthermore by-pass of the binder can be set low.

According to one embodiment, bitumen or another binder is fed to the outlet pipe of the stone material in a slanting angle in relation to the streaming direction of the stone material. More preferably the binder is fed by counter-flow principle, or the binder stream is given a velocity component, that is opposite in relation to the streaming direction of the stone material. In a preferred embodiment illustrated by FIGS. 7a and 7b, the binder is fed from sprays 74 upbevelled to the feeding tube 72′. Furthermore, if spraying is sufficiently strong, the binder bounces from the inside wall of the outlet pipe in a manner shown with arrows and a longer adhesion time is achieved. Special advantages of a counterflow technique is that the adherence of the binder to the stone material improves and the lower surface of the stone material can efficiently be contacted with the binder, in which case the coating will become durable and even.

Combinations of above mentioned embodiments are also possible. The liquid stream can, for example, be brought to a spiral-like movement orientating from down to up to the outlet pipe of the solid material, whereupon its speed has a tangential component as well as a counterflow component.

1. Method for producing a coating layer consisting of a solid material and a liquid onto a substrate, according to which method;
the solid material is contacted with the liquid in order to form a mixture,
the mixture containing the solid material and the liquid is sprayed onto the substrate,
a liquid stream is formed from the liquid,
the solid material is slung as a continuous stream through the liquid stream in order to contact the solid material with the liquid, and
the flow of the solid material passed through the liquid is directed towards the substrate for coating thereof.

2. The method according to claim 1, wherein a spray, a film or a similar stream having a flattened cross-section is formed of the liquid.

3. The method according to claim 1, wherein the liquid comprises a binder.

4. The method of claim 3, wherein the binder is selected from the group of binders which harden at a normal temperature and which is contacted with the solid material in melt phase, or the binder is selected from the group of binders which are liquid but which harden through a chemical reaction within a suitable time period on the surface of the coated area.

5. (canceled)

6. The method according to claim 1, wherein the solid material is stone, crushed glass, polymer pellets, stone coal, rubber or crushed ceramics or crushed concrete or mixtures thereof, metal pieces, metal ore or ice.

7. The method according to claim 1, wherein the solid material exhibits a granular size of 0.1 to 20 mm.

8. The method according to claim 1, wherein bitumen, molten sulphur, molten resins and polymers as molten or oligomers are used as the binder, which on the application site are capable of hardening under the influence of UV light or a catalyst fed together with the material, or water or mixtures or combinations of the aforesaid.

9. (canceled)

10. The method according to claim 1, wherein the solid material is pretreated with a liquid, especially with the binder, before leading it through the liquid stream.

11. The method according to claim 10, wherein from 1 to 50 weight % of the liquid, especially binder, is brought onto the solid material before slinging it through the liquid stream.

12. The method according to claim 1, wherein
solid material is slung to a tube having at least partially curvilinear cross section, and
the liquid is fed to the said at least partially curvilinear tube essentially tangentially in order to bring the solid material into contact with the liquid.

13. (canceled)

14. An apparatus for forming a mixture of a solid material and a binder, which apparatus comprises;
feeding means for the solid material;
feeding means for the binder
a mixing zone for the solid material and the binder provided by the feeding means, wherein the solid material and the binder are mixed together
an accelerating means for the solid material which is provided with an inlet coupled with the feeding means for the solid material and an outlet for the accelerated solid material, the accelerating means being capable of accelerating solid material fed through the inlet to a desired velocity with the aid of mechanic energy and said accelerated solid material being removable in the form of a continuous flow through the outlet and
near the outlet arranged feeding nozzles of the binder that have been connected to the source of the binder and with aid of which the binder can be sprayed to the stream of the solid material,
wherein the binder stream is arranged in front of the outlet in order to provide a mixing zone such that the flow of solid material withdrawn from the accelerating means is forced to pass through the flow of the binder.

15. The apparatus according to claim 14, wherein the feeding nozzles have been adapted so that binder stream can be carried out as flattened stream having a direction of the stream at least partially transversal, preferably essentially transversal, in relation to the stream of the accelerated solid material.

16. The apparatus according to claim 14, wherein the accelerating means for the solid material comprises a centrifugal centrifuge or a compartment centrifuge.

17. The apparatus according to claim 15, further comprising a receiving means for collecting the unused liquid binder which receiving means is arranged on the opposite side of the solid material flow with respect to the feeding nozzles of the binders.

18. The apparatus according to claim 14, wherein the feeding nozzles are arranged to form a binder spray or binder film directed towards the receiving means.

19. (canceled)

20. The apparatus of claim 18, wherein there are several rotating feeding slings in parallel and that between them there are as modules a dividing wall and the material to be slung can be fed to each width modules in a separately controllable amount.

21. The apparatus according to claim 14, wherein the feeding nozzles of the binder are lip slit nozzles, the width of the slit being adjustable.

22. The apparatus according to claim 14, wherein the feeding nozzles of the binder comprises a plurality of conical feed nozzles from which the binder can be fed in the form of liquid cones, the nozzles being arranged in such a manner that the liquid cones formed by them overlap each other in such a way that the liquid amount of the overlapping portions of the liquid cones does not differ more than 10% from the liquid amount of the other parts.

23. (canceled)

24. The apparatus according to claim 14, wherein
the outlet for the solid material has at least partially curvilinear cross section, and the feeding nozzles are arranged to feed the binder to the said at least partially curvilinear tube essentially tangentially for the solid material to contact the solid material with the binder.

25. The apparatus according to claim 14, wherein feeding nozzles are arranged to feed the binder to the outlet of the solid material at least partially in opposite direction to the direction of the solid material stream, preferably on a slant to the direction of the solid material stream.

26. (canceled)
